(19) United States
(12) Patent Application Publication
(10) Pub. No.: US 2005/0166223 A1
(43) Pub. Date: Jul. 28, 2005

(54) Access allowance based on regions

(75) Inventor: Raymond J. Krasinski, Suffern, NY (US)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/511,311

(22) PCT Filed: Apr. 15, 2003
(86) PCT No.: PCT/IB03/01607

Related U.S. Application Data
(60) Provisional application No. 60/373,251, filed on Apr. 17, 2002.
(60) Provisional application No. 60/432,895, filed on Dec. 12, 2002.

(51) Int. Cl. H04N 7/025

(52) U.S. Cl. 725/35; 725/22

(57) ABSTRACT

A device (10) for receiving content includes a memory (12) which stores a descriptor; and a processor (18) which reads the descriptor and an origin code embedded in the content. The processor (18) compares the descriptor with the origin code, and allows content access, such as display of the content onto a screen (20), when the descriptor is substantially identical to the origin code. The descriptor indicates the region where the device may be useable, while the origin code indicates the origin of broadcast of the content (14). Alternatively or in addition, the descriptor may indicate the time zone where the device is useable and the origin code indicates the time zone of origin of the broadcast content (14). The device (10) prevents content access such as display when the content code included in the content (14) does not match the descriptor stored in the memory (12) of the device (10). Further, usage rules may be embedded in the content (14), and the processor (18) is configured to read the usage rules and allow content access in accordance with the usage rules.

The invention relates to allowing display of content onto a medium based on regions and usage rules. More particularly, source content is allowed to be displayed onto a screen based on the usage rules, such as if identical region codes are detected in the source content and the display apparatus.

Typically, television broadcasts may be viewed without restriction. Broadcast content may be data from television such as ATSC (American Television Standards Committee) television broadcast stream, radio, satellite, or Internet such as web pages, web broadcasts, DVB (Digital Video Broadcasts) whether terrestrial or via satellite. To increase revenue, it is highly desirable for broadcasters to control when and where broadcast content may be viewed. Accordingly, there is a need to control when and where broadcast content may be viewed.

According to the invention, a device for receiving content includes a memory which stores a descriptor; and a processor which reads the descriptor and an origin code embedded in the content. The processor compares the descriptor with the origin code, and allows access to the content, such as display onto a screen, when the descriptor is substantially identical to the origin code and/or in accordance with usage rules embedded in the content for access thereof. The descriptor indicates the region where the device may be useable, while the origin code indicates the region of broadcast of the content. Alternatively or in addition, the descriptor may indicate the time zone where the device is useable and the origin code includes the time zone of broadcast of the content. The device prevents content access when the content embedded time zone does not match the time zone included in the device.

Further features and advantages of the invention will become more readily apparent from a consideration of the following detailed description set forth with reference to the accompanying drawing, which specifies and shows a preferred embodiment of the invention; and in which:

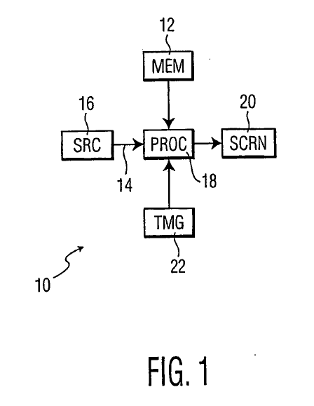

FIG. 1 shows a receiver according to present invention.

The invention, together with attendant advantages, will be best understood by reference to the following detailed description of the preferred embodiment of the invention, taken in conjunction with the accompanying drawing.

A device and method for receiving content is described where accessing the content, such as displaying the content on a screen or providing the content to a speaker for example, is allowed only after certain criteria are met, such as having identical or substantially identical regions codes imbedded in the device and the received content. Regions codes may be embedded in the content which may be data stream from any source, such as radio, television, Internet or provided on any storage product such as tapes, CDs (Compact Disks), DVDs, solid state memories or any other known memory devices, or combinations thereof. The content may be distributed by any means or medium such as via air, including satellite or any long or short range wireless transmission systems; wires such as cable including fiber optics.

In the following description, numerous specific details are set forth, such as specific type of media and content, in order to provide a thorough understanding of the present invention. However, it will be obvious to one skilled in the art that the present invention may be practiced without these specific details. In other instances, well known systems have not been set forth in detail in order to not unnecessarily obscure the present invention.

The illustrative embodiment described herein is an embodiment of a case where the present invention is applied to a television receiver where the content includes television signals such as programming or movies. However, those skilled in the art will appreciate that the receiving device and content may be any other receiving devices and content, such as playback devices of tape or disk or any storage medium, radio or Internet devices and content, where the content may be any type of data or signal, such as signals disclosed in U.S. patent application Ser. No. 09/471,750, and published as International Publication No. WO 01/49030, which is incorporated herein by reference in its entirety, and discloses representing rating systems along with region information in a data structure stored in a memory of a multimedia system. The signals or data stream may be from any source and distributed by any means or medium, such as audio or video stream distributed through the Internet or television and radio signals.

In one embodiment shown in FIG. 1, a receiving apparatus 10 is provided for receiving and playback of content. The receiving apparatus 10 may be any type of a receiver having any tuner, such as radio and television tuners like ATSC or DVB tuners. Alternatively or in addition, receiving apparatus 10 may be any type of a playback device such as a tape, and an optical DVD or CD playback device and for example. Illustratively, the receiving apparatus 10 is a television receiver with a tuner configured to receive ATSC television broadcast stream. For brevity, details of the receiving apparatus 10 that are not directly related to the present invention, such as the tuner, reception means and other circuits are not included herein, but are well known in the art.

The television receiver 10 includes a memory 12 where, at time of manufacture for example, at least one descriptor or region code is stored therein which may be a region such as the United States or Europe. Users have no access to write or change data stored in this memory 12 and thus cannot change or store new descriptors or region codes therein. Additional or alternate descriptors may be in television receiver 10 such as time zones, e.g., Pacific, Central, Mountain, or Eastern time zones of the United States. The television receiver 10 is configured to receive content 14 from a source 16, such as ATSC television broadcast stream having at least one descriptor or origin code embedded in therein. The television receiver 10 includes a processor 18, which is configured to read the descriptor embedded in the television memory 12 and an origin code embedded in the content 14. The processor 18 allows content access, e.g., display of the content 14 onto a screen 20, when the descriptor of the television 10 is substantially identical to origin code of the content 14.

According to the present invention, at least one region code is imbedded in the content 14. For example, in the illustrative case where the content 14 is broadcast television signals in the United States, a descriptor such as at least one region code indicative of the origin of the broadcast content is added to the ATSC (American Television Standards Committee) television broadcast stream. The descriptor may be added to any signal or content 14, for example, in pre-existing or new packets of high definition video broadcast signals. Such signals are typically packet based, having packets containing video and audio content for all of the broadcast channels, and packets that describe how to demodulate (or break apart) the signal into viewable video. Such signals also include informational packets embedded therein, such as the time the signal was broadcast as well as program guide information that describe and aid in using the content.

The informational packets, which are already embedded within the broadcast, may be expanded to include region codes or other descriptors, such as time zone of the broadcast origin and/or time of broadcast as well as usage rules for accessing the content and control, e.g., prevent, copying thereof Alternatively or in addition, desired descriptors may be included in a new packet added to the broadcast The content descriptors may be used by the receiver 10 that is configured to determine whether the content could be viewed, copied or retransmitted.

Accordingly, the ATSC television broadcast stream for example may include descriptors that indicate the origin region of broadcast of the content 14, the time zone of the broadcast origin, and/or time of broadcast of the content 14, e.g., rounded to the nearest hour, as well as the usage rules. Other descriptors may also be included for use in allowing and/or preventing viewing, reproduction, playback and/or recordation using properly configured receivers, such as the television receiver 10 as well as special drives and disk as disclosed in U.S. Patent Application No. 60/432,889(U.S. Provisional Patent Application No. 60/372,893, Attorney Docket No. US 020,116), entitled Recording Allowance Based on Regions, by Raymond Krasinski who is also the inventor of the present application, where substantially identical descriptors are also included in the device memory and disk for comparison and allowance of content reproduction. Illustratively, these descriptors can be similar to the program related descriptors already carried in the digital television broadcast data stream and thus will not affect the quality of service of the digital television broadcast.

The processor 18 of the television receiver 10 is configured, prior to allowing access to the content 14, to read and compare the descriptor(s) embedded in the content 14 and the descriptor(s) embedded in the receiver 10, and allow content access, such as display of the content 14 on the screen 20, when the content descriptor(s) and the device descriptor(s) are substantially identical. Alternatively, the processor 18 allows content display in accordance with the usage rules embedded in the content 14. For example, depending on the region codes and/or time zones embedded the content 14 and the receiver 10, the usage rules may indicate to allow content display after a predetermined time from the current time provided by a timing module 22 of the receiver 10. To prevent tampering by the user, the current time and time zone can be extracted periodically or at random from the broadcast content or other signals with time and date information, such as through the Global Positioning Satellite signals.

Adding or embedding content descriptors as well as usage rules to broadcast content, and device descriptors in receivers, and configuring the receivers to read and compare content and device descriptors as well as usage rules, and allow access to the content based on the content, and device descriptors and/or compliance with the usage rules provides a system and method that allow control of viewing and copy protection of the broadcast content from retransmission outside of its intended broadcast region.

Finally, the above-discussion is intended to be merely illustrative of the present invention and should not be construed as limiting the appended claims to any particular embodiment or group of embodiments. For example, the processor 22 may be a dedicated processor for performing in accordance with the present invention or may be a general-purpose processor wherein only one of many functions operates for performing in accordance with the present invention. The processor may operate utilizing a program portion, multiple program segments, or may be a hardware device utilizing a dedicated or multi-purpose integrated circuit. The above system utilized for allowing content reproduction may be utilized in conjunction with further systems. Thus, while the present invention has been described in particular detail with reference to specific exemplary embodiments thereof, it should also be appreciated that numerous modifications and changes may be made thereto without departing from the broader and intended spirit and scope of the invention as set forth in the claims that follow. The specification and drawing are accordingly to be regarded in an illustrative manner and are not intended to limit the scope of the appended claims.

In interpreting the appended claims, it should be understood that:
the word “comprising” does not exclude the presence of other elements or acts than those listed in a given claim;
the word “a” or “an” preceding an element does not exclude the presence of a plurality of such elements;
any reference signs in the claims do not limit their scope;
several “means” may be represented by the same item or hardware or software implemented structure or function; and
each of the disclosed elements may be comprised of hardware portions (e.g., discrete electronic circuitry), software portions (e.g., computer programming), or any combination thereof.

1. A device (10) for receiving content (14) comprising:
a memory (12) which is configured to store a descriptor; and
a processor (18) which is configured to read said descriptor and an origin code embbedded in said content (14);
wherein said processor (18) is further configured to allow access of said content (14) when said descriptor is substantially identical to said origin code

2. The device (10) of claim 1, wherein said processor (18) is further configured to allow at least one of video signals of said content (14) to be displayed onto a screen (20) and audio signals of said content to be heard on a speaker when said descriptor is substantially identical to said origin code.

3. The device (10) of claim 1, wherein usage rules are further embedded in said content (14); said processor (18) being further configured to read said usage rules and determining said access of said content (14) based on said usage rules.

4. The device (10) of claim 1, wherein usage rules are embedded in said content (14); said processor (18) being configured to obey said usage rules in determining said access of said content (14).

5. The device (10) of claim 4, wherein said usage rules are related to allow said access of said content (14) based on said origin code and said descriptor.

6. The device (10) of claim 1, wherein said descriptor includes a region code indicative of a region said device (10) is useable, and said origin code is related to an origin of said content (14).

7. The device (10) of claim 1, wherein said descriptor includes a device time zone indicative of regions said device (10) is useable, and said origin code includes a content time zone indicative of an origin of said content (14).

8. The device (10) of claim 7, wherein said device time zone is obtainable from a timing module (22) of said device (10).

9. A method for accessing of content (14) of a device (10) comprising:
reading a descriptor embedded in said (10) device;
reading an origin code embedded in said content;
comparing said descriptor with said origin code; and
allowing access of said content (14) when said descriptor and said origin code are substantially identical.

10. The method of claim 9, wherein said allowing act allows at least one of video signals of said content (14) to be displayed onto a screen (20) and audio signals of said content (14) to be heard on a speaker when said descriptor is substantially identical to said origin code.

11. The method of claim 9, further comprising:
reading usage rules embedded in said content (14); and
determining said access of said content (14) based on said usage rules.

12. The method of claim 9, further comprising:
reading usage rules embedded in said content (14); and
obeying said usage rules in determining said access of said content (14).

13. The method of claim 12, wherein said usage rules are related to allowing said access of said content (14) based on said origin code and said descriptor.

14. The method of claim 9, wherein said descriptor includes a region code indicative of a region said device (10) is useable, and said origin code is related to an origin of said content (14).

15. The method of claim 9, wherein said descriptor includes a device time zone indicative of regions said device is useable, and said origin code includes a content time zone indicative of an origin of said content (14).

16. The method of claim 15, further comprising obtaining said device time zone from a timing module of said device (10).

17. The method of claim 9, further comprising:
storing said descriptor in a memory (12) of said device (10); and
embedding an origin code in said content (14).

18. A signal embodied in a carrier wave comprising:
content (14) for access by a device (10); and
a content code indicative of an origin of said signal;
wherein said signal is allowed to be accessed when said content code is substantially identical to a device code imbedded in said device (10).

19. The signal of claim 18, further comprising usage rules, wherein said signal is allowed to be accessed based on usage rules.

20. The signal of claim 18, wherein said content code includes a first time zone of origin of a broadcast of said content (14), said signal being allowed to be accessed by said device (10) when a second time zone included in said device (10) is substantially identical to first time zone.
